(19) United States
(12) Patent Application Publication
(10) Pub. No.: US 2004/0234675 A1
(43) Pub. Date: Nov. 25, 2004

(54) System and method for manufacturing aerated confections

(76) Inventors: Pradip K. Roy, Grand Rapids, MI (US); Mark de Bruijn, Heemstede (NL)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/843,006

(22) Filed: May 11, 2004

Related U.S. Application Data
(60) Provisional application No. 60/469,650, filed on May 12, 2003.

(51) Int. Cl. A23G 3/00

(52) U.S. Cl. 426/660

(57) ABSTRACT

The subject invention relates to a system and method for manufacturing aerated confections, more specifically, multi-colored aerated confections. The system includes a mixer for mixing ingredients into a mixture, a cooker downstream from the mixer, and a buffer vessel to hold the mixture. A vessel pump transports the mixture from the buffer vessel to an aerator station. The aerator station comprises a single aerator and a plurality of additive stations. After aerating the mixture, a manifold divides the mixture into a plurality of streams and pumps the streams to the additive stations. Each of the plurality of streams has a control pump to pump the mixture from the aerator in predetermined portions. An extruder is positioned downstream from the additive stations and in fluid communication with each of the streams to extrude the predetermined portions into the aerated confection.

### CROSS-REFERENCE TO RELATED APPLICATIONS

This application claims priority to provisional patent application 60/469,650 which was filed May 12, 2003.

### BACKGROUND OF THE INVENTION

1) Field of the Invention

The subject invention relates to a system and a method for manufacturing aerated confections, and more specifically to multi-colored aerated confections.

2) Description of Related Art

Various related art systems are known for manufacturing aerated confections. These systems include mixers for mixing ingredients into a mixture to form an aerated confection, cookers for cooking the mixture, and buffer vessels for holding the mixture after cooking. The cooked mixture is divided into a plurality of streams and pumped to multiple aerators. Each of the streams is aerated and an additive, such as color, is then added to each of the streams. The streams are then extruded into the aerated confection.

One such system and method having multiple aerators is disclosed in U.S. Pat. Nos. 6,435,455 and 6,180,158, both to Zietlow et al. These patents disclose dividing the cooked mixture into the multiple streams, adding an additive, such as color, to the streams, and then aerating each one of the streams. Such a system and method requires multiple aerators to form a single aerated confection. Aerators are very expensive and increase the cost of producing the aerated confections. Further, when the system is changed to produce a different aerated confection having different colors, each of the aerators must be cleaned prior to switching. This is very time and labor intensive which increases the cost of producing the aerated confection.

The related art systems and methods are characterized by one or more inadequacies. Accordingly, it would be advantageous to provide a system and method that overcomes these adequacies. Specifically, it would be advantageous to provide a system and method that produces aerated confections with reduced effort and cost. Further, it would be advantageous to provide a system and method for precisely controlling the formation of the aerated confection having multiple additives.

### BRIEF SUMMARY OF THE INVENTION

The subject invention provides a system and method for manufacturing aerated confections. The system includes a mixer for mixing ingredients into a mixture to form an aerated confection and a cooker downstream from the mixer for receiving the mixture and for cooking the mixture. The mixture is held in a buffer vessel downstream from the cooker and the buffer vessel is in fluid communication with at least one vessel pump for pumping the mixture from the buffer vessel. An aerator receives the mixture from the buffer vessel and aerates the mixture. After aeration, a manifold divides the mixture into a plurality of streams each having a predetermined portion of the mixture. A control pump in fluid communication with each of the streams pumps the mixture from the manifold to an additive station to add an additive thereto. The streams are then passed to an extruder downstream from the additive stations to extrude the predetermined portions into the aerated confection.

The method includes the steps of mixing ingredients into the mixture, cooking the mixture, and aerating the mixture after the mixture has been cooked. The mixture is then divided into a plurality of streams each having a predetermined portion of the mixture and an additive is added to at least one of the streams. The streams are then extruded into single color streams or co-extruded into multi-colored streams of specific geometry simultaneously to form the aerated confection.

The subject invention overcomes the inadequacies that characterize the related art systems and methods. The subject invention provides a system and method of producing aerated confection at a reduced effort and cost by incorporating a single aerator to aerate the mixture prior to adding multiple additives. Further, the subject invention allows for precise control of the mixture as the mixture is being extruded into the aerated confection. This precise control allows the aerated confection to have more detail and an improved appearance, especially when the aerated confection has multiple colors.

### BRIEF DESCRIPTION OF THE SEVERAL VIEWS OF THE DRAWING

Other advantages of the present invention will be readily appreciated, as the same becomes better understood by reference to the following detailed description when considered in connection with the accompanying drawings wherein:

FIG. 1 is a schematic view of a system for producing an aerated confection according to the subject invention;

FIG. 1A is a close-up view of a plurality of streams entering an extruder;

FIG. 2 is a schematic view of another embodiment of the system for producing the aerated confection according to the subject invention;

FIG. 3 is a schematic view of yet another embodiment of the system for producing the aerated confection according to the subject invention;

FIG. 4 is a schematic view of still another embodiment of the system for producing the aerated confection according to the subject invention;

FIG. 5 is a schematic view of still yet another embodiment of the system for producing the aerated confection according to the subject invention;

FIG. 6 is a top view of an extruder for extruding the aerated confection;

FIG. 7 is a side view of the extruder;

FIG. 8 is a cross-sectional view of the extruder;

FIG. 9 is a rear view of a nozzle connected to the extruder;

FIG. 10 is a side view of the nozzle;

FIG. 11 is a front view of the nozzle having a die thereon for shaping the aerated confection; and

FIG. 12 is a perspective view of the aerated confection that is formed from the extruder and die.

### DETAILED DESCRIPTION OF THE INVENTION

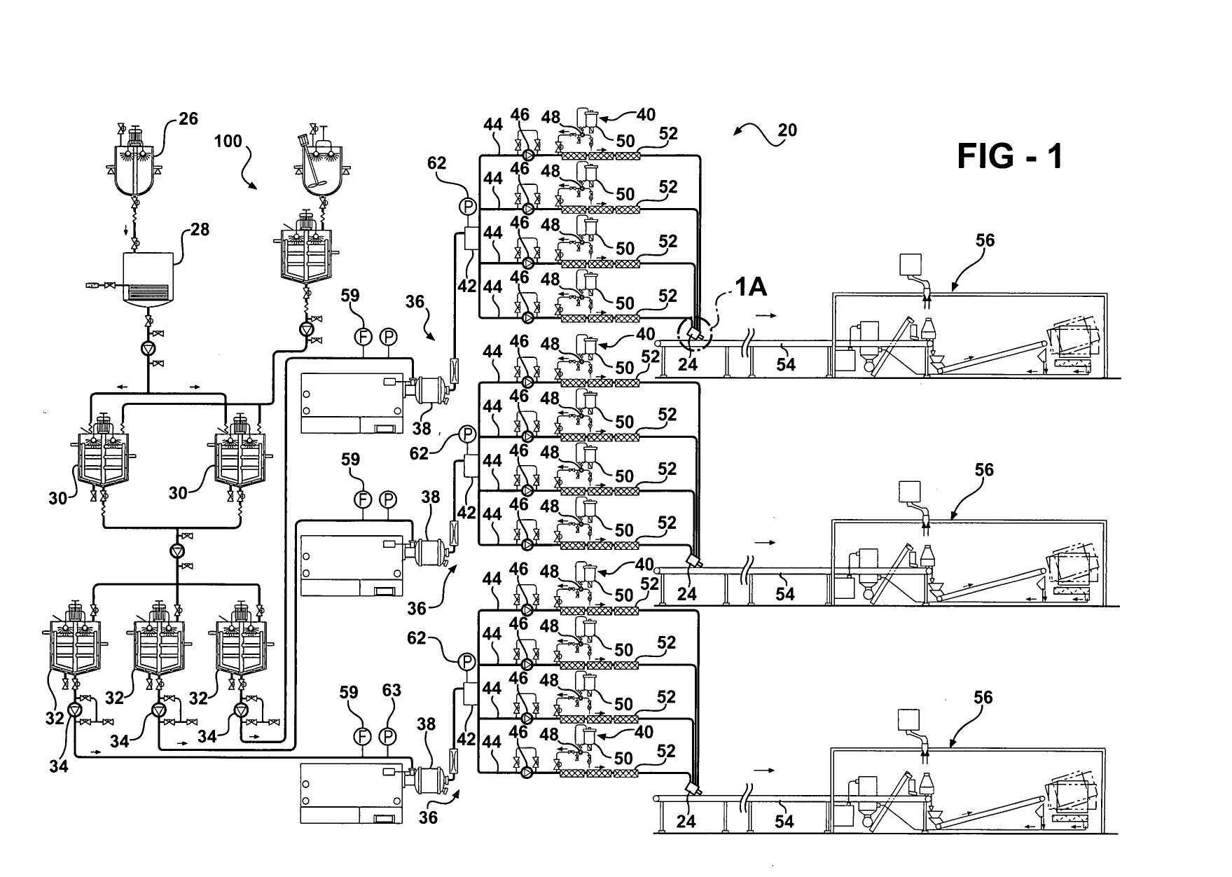

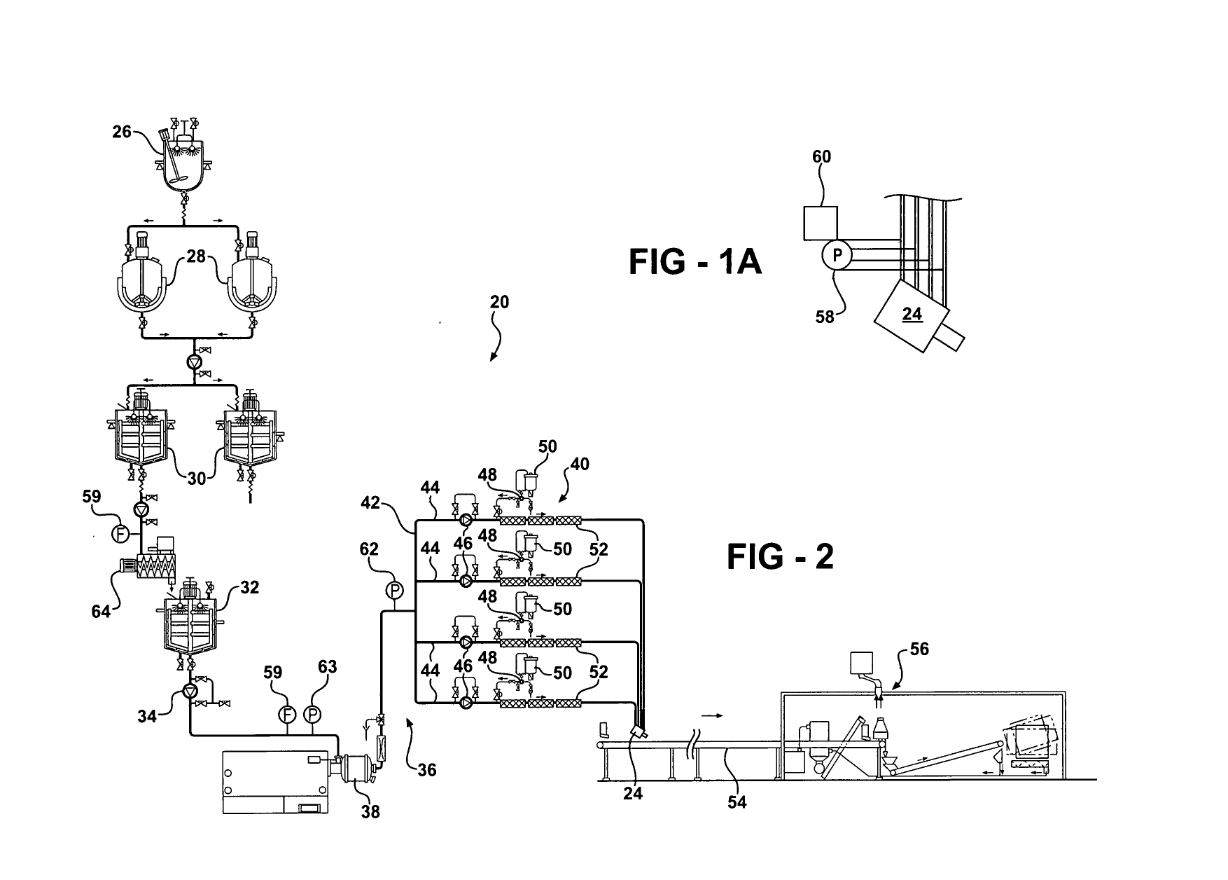

Referring to the Figures, wherein like numerals indicate like or corresponding parts throughout the several views, a system for manufacturing aerated confections 22 (See FIG. 12) is disclosed generally at 20 in FIG. 1. FIGS. 1-5 illustrate general schematics of alternate embodiments of the system 20 according to the subject invention. More specifically, the subject invention provides the system 20 for forming multi-colored aerated confections 22. The system 20 and method provides better flow control of mallow to an extruder 24 that results in a better overall aerated confection 22. In addition, the present invention provides a less expensive system 20 for the manufacture of aerated confections 22, such as marshmallows and marbits, as will be described below. The system 20 is particularly usefully for manufacturing the aerated confection 22 under low extrusion pressure, as compared to the related art systems that require high pressure. The extruder 24 may include a single fluid extruder or a multi-fluid extruder.

The system 20 will be described with reference to the embodiment shown in FIG. 1 and the alternate embodiments will follow. The system 20 includes a mixer 26 for mixing ingredients into a mixture to form the aerated confection 22. The mixing of the ingredients creates the initial mixture or mallow. The ingredients of the mallow are well known to those of ordinary skill in this art and have been disclosed in numerous prior art patents, trade journals and treatises related to this field. The mallow can be selected from any of these well-known recipes or can be made from novel recipes to be developed. It is important to appreciate that the selected recipe for making the mallow mixture is important to the resultant aerated confection 22, but does not form part of the novelty of the present invention. The mixture is then cooked in a cooker 28 downstream from the mixer 26 and the cooked mixture cools in a cooling tank 30. The cooker 28 may be a batch cooker as illustrated in the Figures, or it may be a continuous cooking system known to those skilled in the art. Typically, while the mixture is in the cooling tank 30, corn syrup and gelatin are added. Other additives that may be added are, but not limited to, SHMP and dextrose. One station is shown generally at 100 for adding the additives.

From the cooling tank 30, the mixture will be held in a buffer vessel 32. The buffer vessel 32 is in place to ensure that sufficient amounts of the mixture are available for proper operation of the system 20. At least one vessel pump 34 is in fluid communication with the buffer vessel 32 for pumping the mixture from the buffer vessel 32 to an aerator station 36. One such aerator station that is commercially available is a MondoMixer. The aerator station 36 comprises a single aerator 38 and a plurality of additive stations 40. In FIG. 1, the system 20 includes two cooling tanks 30 that feed three buffer vessels 32. Each one of the buffer vessels 32 feeds separate aerator stations 36, i.e. there are three aerator stations 36 illustrated. Therefore, the three aerator stations 36 may feed three different manufacturing lines.

The aerator 38 incorporates air into the mixture, which is known as aerating the mixture. This is an important feature of the present invention. Known aerated confectionary lines for manufacturing multi-colored confectionary products employ an aerator 38 for each additive station 40 used in the multi-colored aerated confection 22. In a typical line manufacturing a four-colored aerated confection 22, the line would include four additive stations 40 with each having an aerator 38. Therefore, four aerators 38 would be required to produce the aerated confection 22. Aerators 38 are an expensive component in the manufacturing line, and as such, the system 20 of the present invention uses only one aerator 38 for aerating the mallow. In the present invention, only one aerator 38 is necessary to make four or more separate colored aerated confections 22, as will be described below.

The mixture, after being aerated, passes to a manifold 42. The manifold 42 divides the mixture into a plurality of streams 44 each having a predetermined portion of the mixture. Each of the plurality of streams 44 passes to the additive station 40 for adding an additive to the predetermined portions of the mixture. The predetermined portions of the mixture are controlled by the flow rate of each of the pumps 46. Preferably, the additive station 40 is a color additive station for adding a color into the stream 44. It should be understood that in addition to adding color, other things such as flavoring, aroma, etc. could be added in the combination if desired. Therefore, since each of the plurality of streams 44 passes to the additive station 40, a different color can be added to each of the streams 44. Referring to FIGS. 1-5, the subject invention is illustrated as having four additive stations 40 for producing a four color aerated confection 22. As should be appreciated, if more than four colors are desired, then the manifold 42 would divide the mixture into more than four streams 44. Alternatively, if fewer colors were desired, then the manifold 42 would divide the mixture into fewer streams 44.

The additive stations 40 include a control pump 46 in fluid communication with each of the streams 44 to pump the mixture from the aerator 38 in the predetermined portions. Alternatively, if the aerated confection 22 uses less than the number of streams 44 as divided by the manifold 42, then the control pump 46 for the undesired stream 44 could be adjusted for zero flow. This allows the system 20 to be employed for manufacturing various colored mixtures without having to modify the equipment of the system 20. For example, the control pumps 46 can be adjusted to a desired percentage of color in the aerated confection 22. The flow from the flow control can be adjusted to any percentage as long as the total flow from the pumps equals 100%. By way of example, with reference to FIG. 12, the desired end product is illustrated as a toucan. The toucan has a red head 84, a black eye 86, a white body 88, and blue tail 90 with the ratio of each element in the final product being 30% for the head, 10% for the eye, 40% for the body, and 20% for the tail. The flow control pumps 46 are adjusted to 30%, 10%, 40%, and 20% to correspond to each portion of the toucan.

Referring back to FIG. 1, each of the additive stations 40 further include an additive pump 48 for pumping the additive in a specified amount into the predetermined portion of the mixture. An additive storage tank 50 is connected to the additive pump 48 for storing the additive to be admixed with the predetermined portion of the mixture. After the additive is mixed with the mixture, the mixture flows through an additive mixer 52 to mix the additive with the predetermined portion of the mixture. Preferably, the additive mixer 52 is a static mixer, but may be a dynamic mixer.

The extruder 24 is positioned downstream from the additive stations 40 and in fluid communication with each of the streams 44 to extrude the predetermined portions into the aerated confection 22. After the aerated confection 22 is extruded from the extruder 24, it is a continuous stream of material that is carried by a conveyor 54 to a cutting station 56. It should be appreciated that dryers, vibrators, etc. may be employed as needed to complete the process. Typically, the aerated confection 22 and the conveyor 54 are covered with starch to assist the cutting of the product and to prevent it from sticking to the conveyor 54.

In order to control the flow of the mixture through the system 20, a control unit 60 is in communication with a first pressure sensor 58, a second pressure sensor 62, the control pumps 46, and the vessel pump 34. Each of the streams 44 has the first pressure sensor 58 to monitor the pressure of the mixture thereof, shown in FIG. 1A. It is to be appreciated that the FIG. 1A may apply to each of the embodiments shown. The first pressure sensor 58 is for fine tuning the flow of the mixture from the extruder as discussed below.

The precision control of the system 20 is through the second pressure sensor 62. When the control pump 46 is pumping the mixture in one of the streams 44 at 10%, but in actuality, the stream 44 is being extruded at 12%, the second pressure sensor 62 will detect a drop in the pressure near the manifold. The control unit 60 will then operate the vessel pump 34 to increase the amount to the manifold. Likewise, if one stream 44 is pumping at 20%, but only being extruded at 18%, the pressure will increase in the stream 44 and will be detected by the second pressure sensor 62, so the vessel pump 34 will slow. The same concept applies to the first pressure sensor 58 as the aerated confection 22 is extruded.

Referring back to FIG. 1, the second pressure sensor 62 may be mounted at the manifold 42 to monitor the pressure of the mixture exiting the aerator 38 and is in communication with the control unit 60. The control unit 60 is also in communication with the vessel pump 34 for adjusting the flow from the vessel pump 34 and into the aerator 38, as described above. By adjusting the flow into the aerator 38, this indirectly adjusts the flow exiting the aerator 38 and entering the manifold 42. If the plurality of streams 44 try to pump more of the mixture than is coming out of the aerator 38, then the vessel pump 34 is increased to pump more into the aerator 38. Since the control unit 60 is in communication with both the vessel pump 34 and the control pump 46, the flow and pressure of the streams 44 is regulated to ensure that the aerated confection 22 is manufactured properly.

The control unit 60 may also be in communication with the additive pump 48 for adjusting an amount of the additive being added to the predetermined portions of the mixtures. Therefore, if a new color is to be added to the aerated confection 22, a new storage tank is connected to the additive pump 48 and the control unit 60 can control the addition of the new color. A third pressure sensor 63 and flow sensors 59 may be used and in communication with the control unit 60 for controlling the flow of the streams 44 more efficiently.

FIG. 2 illustrates an alternate embodiment of the subject invention. This alternate embodiment differs from the schematic of FIG. 1 in that multiple cookers 28 feed only one buffer vessel 32. The single buffer vessel 32 then feeds one aerator station 36 and produces only a single manufacturing line. The aerator station 36, additive stations 40, and the extruder 24 of FIG. 2 are similar to that shown in FIG. 1 and as described above.

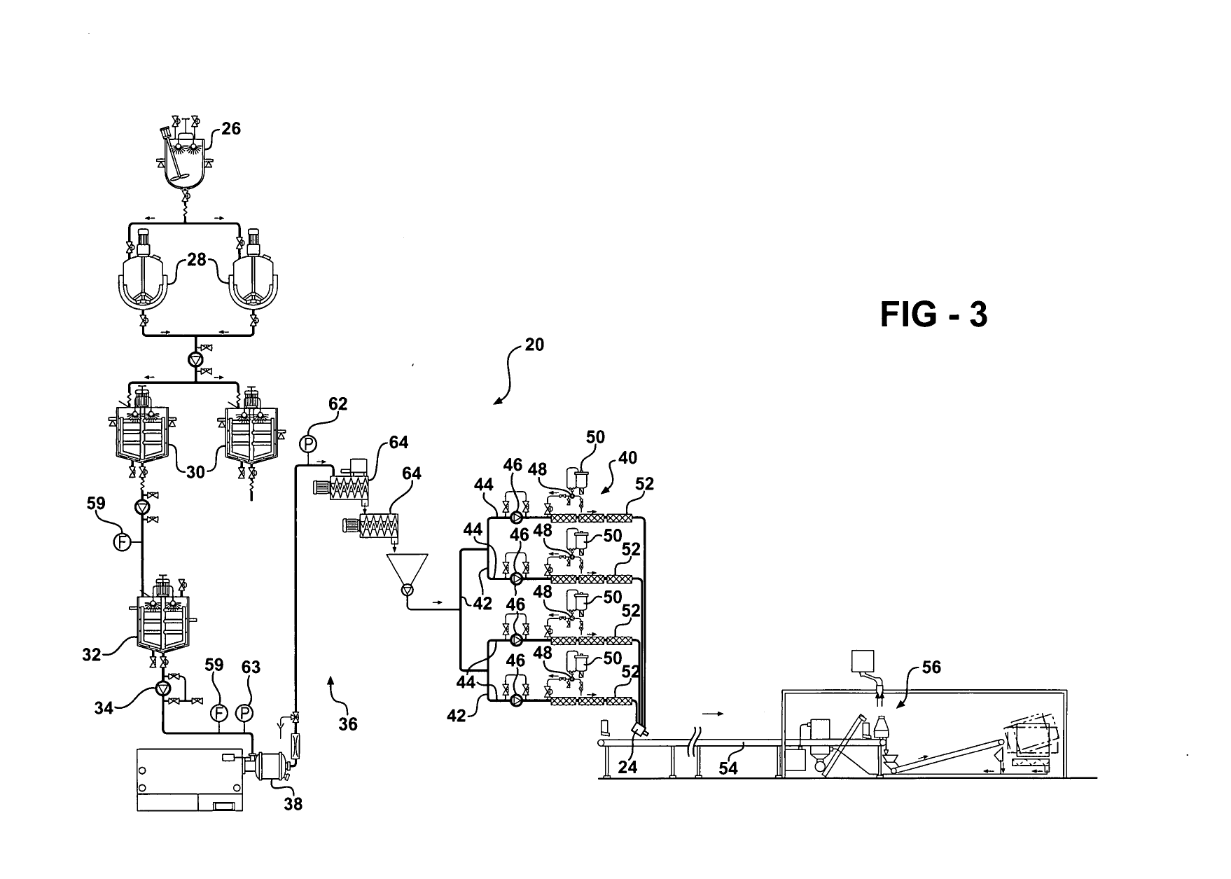

Referring to FIG. 3, yet another embodiment of the subject invention is illustrated. This embodiment differs from the schematic of FIG. 1 in that multiple cookers 28 feed only one buffer vessel 32. The single buffer vessel 32 then feeds one aerator station 36 and produces only a single manufacturing line. The aerator station 36 also includes additional blenders 64 for blending the mixture after being aerated. The manifold 42 then receives the mixture and divides the stream 44 into two streams. Each of the two streams 44 is divided again to feed four additive stations 40. The additive stations 40 and the extruder 24 of FIG. 3 are similar to that shown in FIG. 1 and as described above.

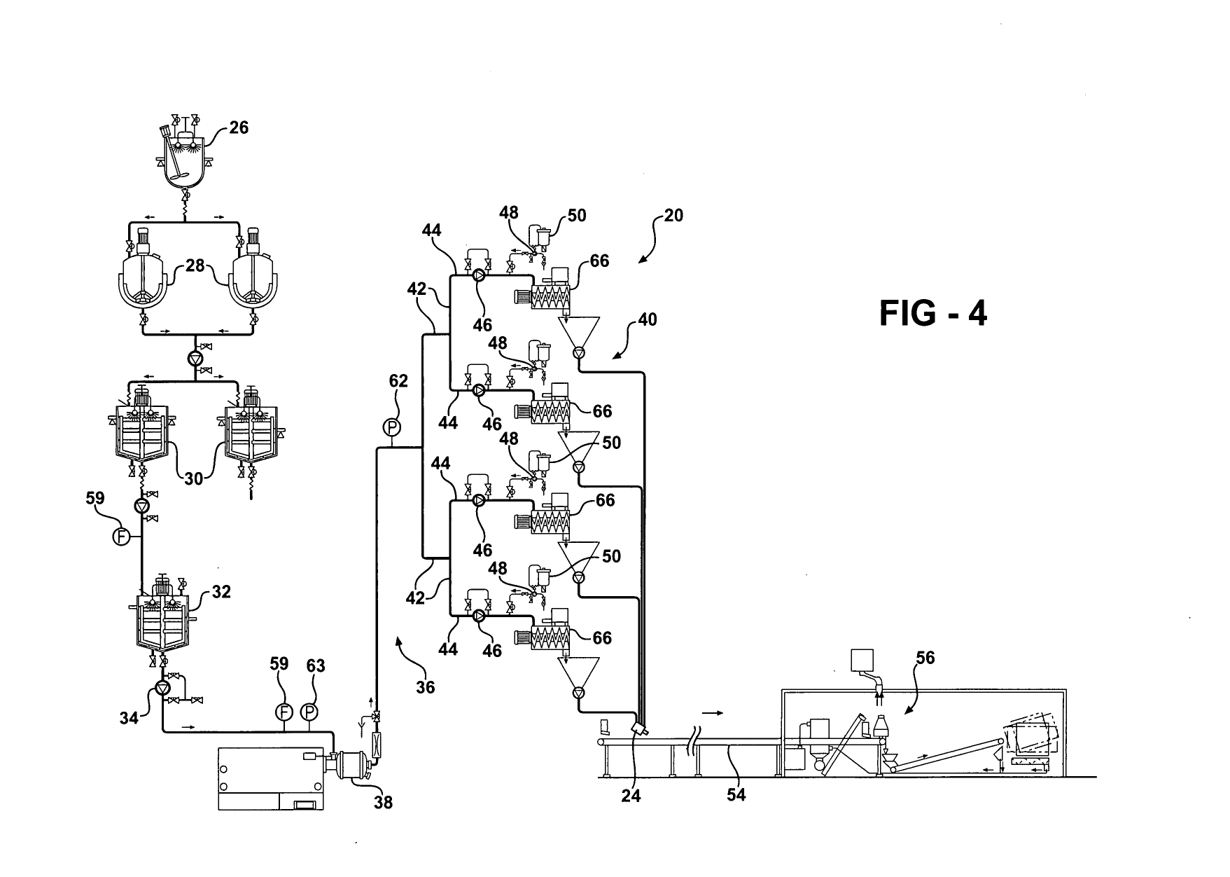

With reference to FIG. 4, still another embodiment of the subject invention is illustrated. This embodiment differs from the schematic of FIG. 1 in that multiple cookers 28 feed only one buffer vessel 32. The single buffer vessel 32 then feeds one aerator station 36 and produces only a single manufacturing line. The manifold 42 divides the stream 44 into two streams and then each of the two streams 44 is divided again to feed four additive stations 40. Each of the additive stations 40 includes additive blenders 66 for blending the additive with the mixture in place of the mixers 26 in FIG. 1. The extruder 24 of FIG. 4 is similar to that shown in FIG. 1 and as described above.

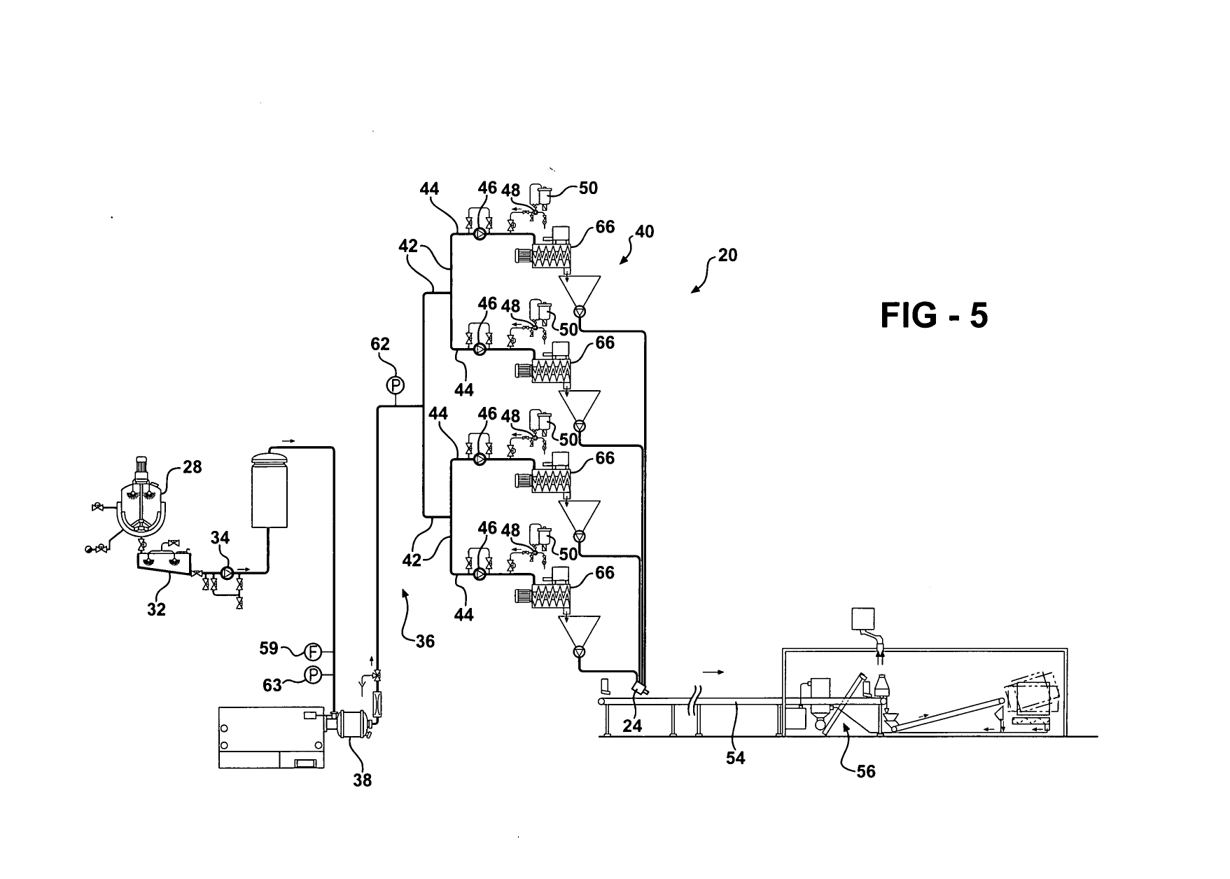

FIG. 5 illustrates yet still another embodiment of the subject invention. This embodiment differs from the schematic of FIG. 1 in that the cooker 28 feeds only one buffer vessel 32. The single buffer vessel 32 then feeds one aerator station 36 and produces only a single manufacturing line. The manifold 42 divides the stream 44 into two streams and then each of the two streams 44 is divided again to feed four additive stations 40. Each of the additive stations 40 includes additive blenders 66 for blending the additive with the mixture in place of the mixers 26 in FIG. 1. The extruder 24 of FIG. 5 is similar to that shown in FIG. 1 and as described above.

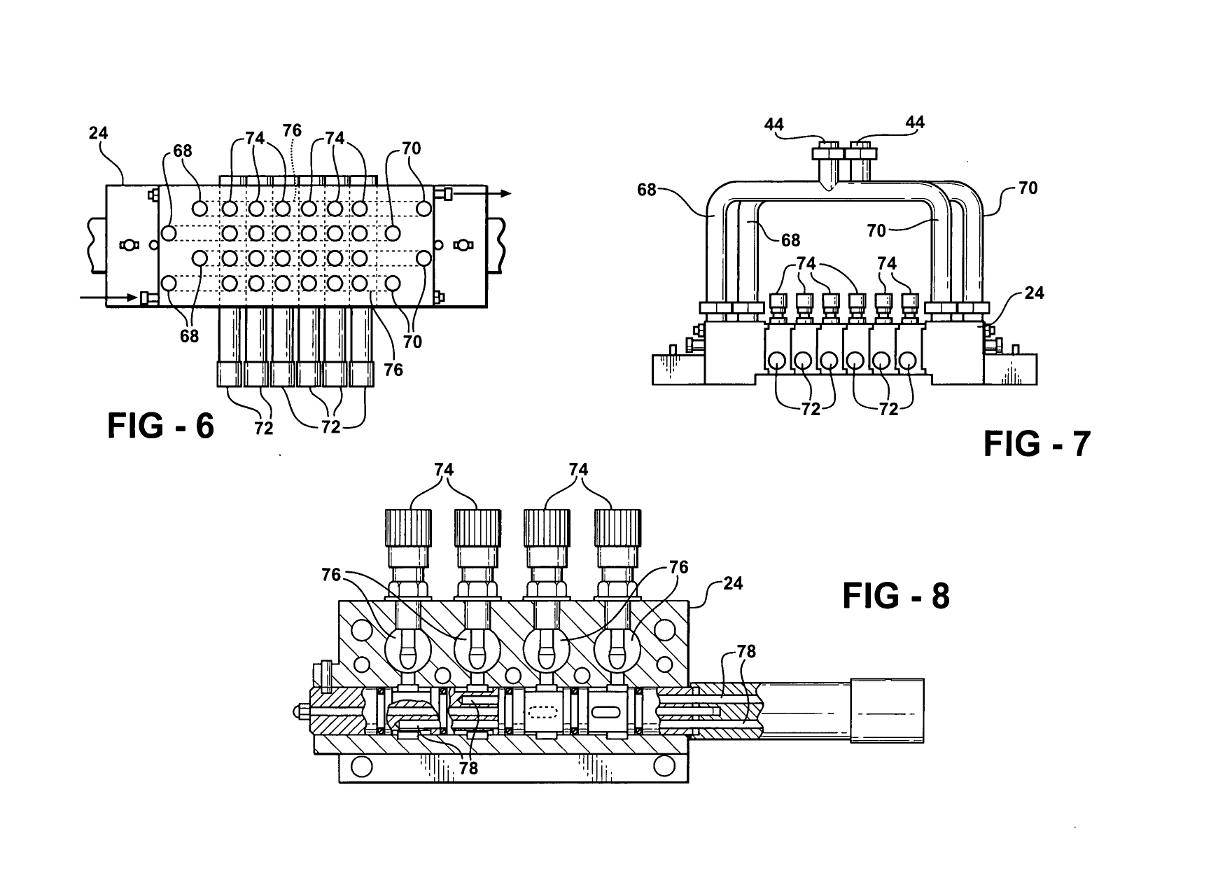

Referring to FIGS. 6-11, the extruder 24 is shown in greater detail. More specifically, FIG. 6 is a top view of the extruder 24. The extruder 24 has a first inlet 68 and a second inlet 70 for receiving each of the streams 44 from the additive stations 40 and for maintaining the predetermined portions of the mixture in the extruder 24. Nozzles 72 extend from one side of the extruder 24 for extruding the aerated confection 22. The extruder 24 has an adjusting knob 74 corresponding to each on of the streams 44 for precisely adjusting the flow into the nozzle 72 of the streams 44.

Referring to FIG. 7, a side view of the extruder 24 is illustrated having the streams 44 divided into the first inlet 68 and the second inlet 70 for entering the extruder 24. The first and the second inlet 70 allow the mixture to enter the extruder 24 from both sides and equalize the pressure within the extruder 24. Referring to FIG. 8, a cross-sectional view of the extruder 24 is shown. The extruder 24 includes a plurality of mixture reservoirs 76 in fluid communication with the inlets for each of the streams 44. When the mixture enters through the first and the second inlet 70, the mixture flows from the edges toward the center of the mixture reservoirs 76. The adjusting knobs 74 extend into each of the mixture reservoirs 76 for finely adjusting the flow of the mixture. Feed pipes 78 extend from each of the mixture reservoirs 76 and engage the adjusting knobs 74. Therefore, the adjusting knobs 74 permit more or less of the mixture to flow into the feed pipes 78. If less flow is desired, then the adjuster knobs are closed and if more flow is desired, then the adjuster knobs are opened.

By adjusting the flow with the adjusting knobs 74, the flow can be precisely controlled. Adjusting the flow with the adjusting knobs 74 changes the pressure within the streams 44, which is detected by the first and the second pressure sensor 62 and monitored by the control unit 60. For example, if the additive pump 48 is pumping at 10% and the adjusting knob 74 is opened to allow more flow from the nozzle 72, then the pressure will drop in the stream 44. The first pressure sensor 58 will detect the pressure change and the control unit 60 will increase the additive pump 48 to restore pressure to 10%.

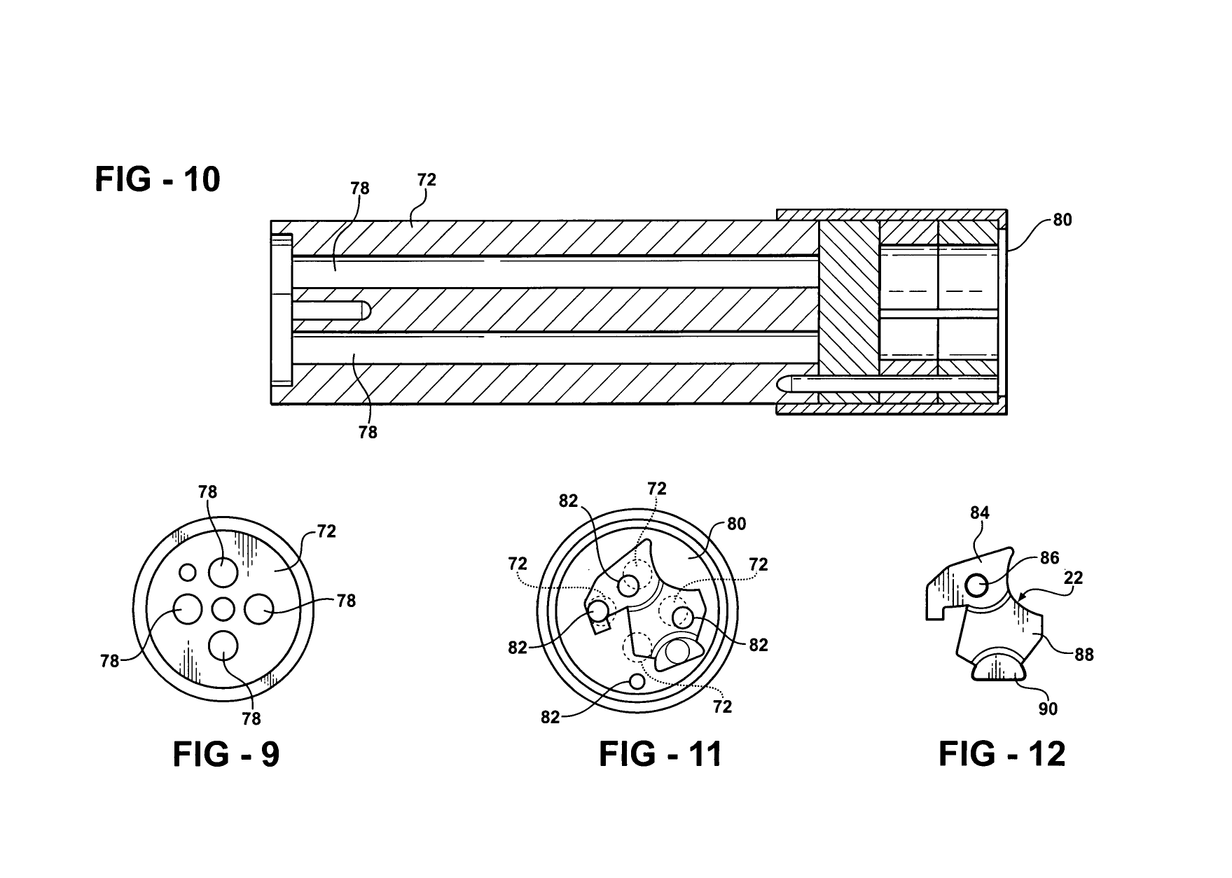

Referring to FIGS. 9-11, the nozzle 72 is illustrated in more detail. The nozzle 72 mounts to the extruder 24 and receives the feed pipes 78 for carrying the mixture to a die 80. FIG. 9 illustrates a rear view of the nozzle 72 for connecting to the feed pipes 78. FIG. 10 is a side view of the nozzle 72 and FIG. 11 is a front view of the nozzle 72 with the die 80 mounted thereto. The die 80 has inlets 82 and mounts to the nozzle 72 such that the inlets correspond to each of the feed pipes 78 to produce the aerated confection 22. The inlets 82 direct the mallow to the desired location to form the aerated confection 22, such as the head 84, eye 86, body 88, and tail 90.

The feed pipes 78 terminate at their respective reservoir such that in any orientation, or phase of rotation, the lines 78 carry the mallow from the same stream 44. The nozzle 72 is capable of being rotated 360 degrees to adjust an orientation of the aerated confection 22 as it is being extruded. When the aerated confection 22 enters the cutting station 56, one orientation of the aerated confection 22 may cut better than another. In order to adjust the orientation, the nozzle 72 is rotated, which rotates the die 80 and the feed pipes 78 such that the respective streams 44 still enter the same feed pipes 78. This ensure that the same color is coming out the same portion of the die 80. By only having to rotate the nozzle 72, the system 20 does not have to be took apart and reassembled when a different orientation of the aerated confection 22 is desired in order to be able to cut the aerated confection 22 into pieces.

The subject invention also provides a method of manufacturing aerated confections 22. The method includes the steps of mixing the ingredients into the mixture, cooking the mixture, and aerating the mixture after the mixture has been cooked. The mixture is divided into the plurality of streams 44 each having a predetermined portion of the mixture after the mixture has been aerated. An additive is added to at least one of the streams 44 having the predetermined portions of the mixture and the streams 44 are simultaneously extruded to form an aerated confection 22. The extruder 24 receives each of the plurality of streams 44 and forces the streams 44 through the die 80 to form the aerated confection 22.

In order to control the extruding of the aerated confection 22 the method includes the step of pumping the mixture from the cooker 28 to the aerator stations 36 and pumping the mixture after being aerated and divided to the additive stations 40. The pressure of the streams 44 is monitored and the pumping of the mixture is adjusted in response to detecting a change in pressure, as described above. The adjusting of the pressure may occur at either the vessel pump 34 or the additive pump 48 or both.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for manufacturing aerated confections, said system comprising:
a mixer for mixing ingredients into a mixture to form an aerated confection;
a cooker downstream from said mixer for receiving said mixture and for cooking said mixture;
a buffer vessel downstream from said cooker for holding said mixture after cooking;
at least one vessel pump in fluid communication with said buffer vessel for pumping said mixture from said buffer vessel;
an aerator receiving said mixture from said buffer vessel to aerate said mixture;
a manifold receiving said mixture after being aerated and dividing said mixture into a plurality of streams each having a predetermined portion of said mixture;
a control pump in fluid communication with each of said streams to pump said mixture from said manifold in said predetermined portions;
an additive station in fluid communication with each of said streams to add an additive to said predetermined portions of said mixture; and
an extruder downstream from said additive stations in fluid communication with each of said streams to extrude said predetermined portions into said aerated confection.

2. A system as set forth in claim 1 wherein each of said additive stations further comprise an additive pump for pumping said additive in a specified amount into said predetermined portion of said mixture.

3. A system as set forth in claim 2 wherein each of said additive stations further comprise an additive storage tank for storing said additive to be admixed with said predetermined portion of said mixture.

4. A system as set forth in claim 3 wherein each of said additive stations further comprise an additive mixer in fluid communication with said stream to mix said additive with said predetermined portion of said mixture.

5. A system as set forth in claim 2 wherein each additive station is further defined as a color additive station for adding a color into said stream such that each color additive stations is a different color.

6. A system as set forth in claim 1 wherein said extruder further comprises an inlet for receiving each of said streams and for maintaining said predetermined portions of said mixture in said extruder.

7. A system as set forth in claim 6 wherein said inlet is further defined as a first inlet and a second inlet.

8. A system as set forth in claim 6 wherein said extruder further comprises a plurality of mixture reservoirs in fluid communication said inlets for each of said streams.

9. A system as set forth in claim 8 wherein said extruder further comprises feed pipes extending from each of said mixture reservoirs.

10. A system as set forth in claim 9 further comprising a nozzle mounted to said extruder and receiving said feed pipes.

11. A system as set forth in claim 10 wherein said nozzle is rotatable relative to said extruder.

12. A system as set forth in claim 11 wherein said feed pipes rotate with said nozzle.

13. A system as set forth in claim 10 further comprising a die mounted to said nozzle having an inlet corresponding to each of said feed pipes to produce said aerated confection.

14. A system as set forth in claim 2 further comprising a first pressure sensor at each of said streams to monitor said pressure thereof.

15. A system as set forth in claim 14 further comprising a second pressure sensor at said manifold to monitor said pressure of said mixture in each of said streams.

16. A system as set forth in claim 15 further comprising a control unit in communication with said first and said second pressure sensors.

17. A system as set forth in claim 16 wherein said control unit is further defined as being in communication with said vessel pump and said control pump to adjust each of said pumps to regulate pressure and flow of said streams.

18. A system as set forth in claim 16 wherein said control unit is further defined as being in communication with said additive pump for adjusting an amount of said additive being added to said predetermined portions of said mixtures.

19. A system as set forth in claim 1 further comprising a cooling tank disposed between said cooker and said buffer vessel for cooling said mixture after cooking.

20. A system as set forth in claim 1 further comprising a cutting station downstream from said extruder for cutting said aerated confection.

21. A method of manufacturing aerated confections, said method comprising the steps of:
mixing ingredients into a mixture;
cooking said mixture;
aerating said mixture after said mixture has been cooked;
dividing said mixture into a plurality of streams each having a predetermined portion of said mixture after said mixture has been aerated;
adding an additive to at least one of said streams having said predetermined portions of said mixture;
extruding said streams having said predetermined portions of said mixture simultaneously to form an aerated confection.

22. A method as set forth in claim 21 further comprising the step of mixing said predetermined portion of said mixture and said additive to disperse said additive in said predetermined portion of said mixture.

23. A method as set forth in claim 21 further comprising the step of cutting said aerated confection after extrusion to form aerated pieces.

24. A method as set forth in claim 21 wherein the step of extruding further comprises the step of receiving each of said plurality of streams and forcing said streams through a die.

25. A method as set forth in claim 21 further comprising the step of pumping said mixture after cooking to be aerated.

26. A method as set forth in claim 25 wherein the step of dividing said mixture further comprises the step of pumping said mixture after being aerated into each of said streams.

27. A method as set forth in claim 26 wherein the step of extruding further comprises the step of monitoring a pressure of the mixture in the streams and adjusting the pumping of the mixture after being aerated in response detecting a change in the pressure.

28. A method as set forth in claim 27 wherein the step of extruding further comprises the step of adjusting the pumping of the mixture after cooking and prior to aerating the mixture in response to detecting a change in the pressure.

29. A method as set forth in claim 21 wherein the step of adding an additive is further defined as adding a color additive to each of the streams.

30. A method as set forth in claim 29 wherein the step of adding a color additive is further defined as adding a color additive different from one another at each of the streams.
